(19) United States
(12) Patent Application Publication
(10) Pub. No.: US 2024/0383552 A1
(43) Pub. Date: Nov. 21, 2024

(54) EXERCISE BICYCLE SEAT POST

(71) Applicant: Peloton Interactive, Inc., New York, NY (US)

(72) Inventors: Joshua ENGSTROM, Woodinville, WA (US); Sana WAHEED, Woodinville, WA (US)

(21) Appl. No.: 18/667,364

(22) Filed: May 17, 2024

Related U.S. Application Data
(60) Provisional application No. 63/503,016, filed on May 18, 2023.

(51) Int. Cl. B62J 1/08

(52) U.S. Cl. CPC B62J 1/08

(57) ABSTRACT

An apparatus, such as a seat post for an exercise bicycle, is described. The seat post may comprise a vertical post, which is coupled to a frame of the exercise bicycle, a horizontal post, which supports a seat or saddle of the exercise bicycle, and a connector between the vertical post and the horizontal post. The connector may include elongated extensions, such as extensions that are greater than half a width of the connector.

### CROSS-REFERENCE TO RELATED APPLICATIONS

This application claims priority to U.S. Provisional Patent Application No. 63/503,016, filed on May 18, 2023, entitled EXERCISE BICYCLE SEAT POST, which is hereby incorporated by reference in its entirety.

### BACKGROUND

An exercise bicycle may have many different users. For example, a gym, fitness center, hotel, or recreation center may have many users that ride an exercise bicycle throughout a day or week. Similarly, various family members or residents of a house may use one exercise bicycle for their workouts. Thus, the exercise bicycle, to accommodate different users, may include adjustment mechanisms (e.g., seat or handlebar adjustment mechanisms) that facilitate a desired configuration (e.g., a specific size or length configuration) of the exercise bicycle for each of the users.

### BRIEF DESCRIPTION OF THE DRAWINGS

Embodiments of the present technology will be described and explained through the use of the accompanying drawings.

FIG. 1 is a diagram illustrating a suitable exercise bicycle.

FIG. 2 is a diagram illustrating components of a seat post for an exercise bicycle.

FIG. 3 is a diagram illustrating a connector of a seat post.

FIG. 4 is a diagram illustrating an example seat post for an exercise bicycle.

FIG. 5 is a diagram illustrating a cross-sectional view of a seat post.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

An apparatus, such as a seat post for an exercise bicycle, is described. The seat post provides structural integrity to an exercise bicycle, such as an exercise bicycle that accommodates many different users, by having a certain geometry between components, such as between a vertical post, which is coupled to a frame of the exercise bicycle, a horizontal post, which supports a seat or saddle of the exercise bicycle, and a connector between the vertical post and the horizontal post. The connector may include elongated extensions, such as extensions that have a length at least half a width of the connector, or greater (e.g., two thirds the width).

For example, the seat post may include a vertical support post, a horizontal support post, and an elbow connector, where the elbow connector includes a lower extension, disposed within an opening of the vertical support post, having a length that is at least two thirds of a width of the elbow connector, and an upper extension, disposed within an opening of the horizontal support post, having a length that is at least two thirds of the width of the elbow connector.

As another example, the connector may include extensions that have different length ratios, such as ratios where the lower extension is greater than the upper extension, ratios where the upper extension is greater than the lower extension, and so on.

In doing so, the seat post, via the elongated connector (or connector component), may provide structural integrity (e.g., act as a failsafe) and support for riders of an exercise bicycle without the use of additional components or inefficient manufacturing processes. The connector, having extensions of certain length ratios or other geometries, provide the exercise bicycle with a sufficient and suitable support for a seat/saddle in an efficient and/or cost-effective manner, among other benefits.

Various embodiments of the apparatuses or devices will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Seat Post for an Exercise Bicycle

The technology described herein is directed, in some embodiments, to a seat post for an exercise bicycle. For example, the seat post can include an elbow or connector section, which connects or couples a vertical post or component (e.g., a post that mates to a frame of an exercise bicycle to position a seat or saddle) with a horizontal post or component (e.g., a horizontal post that supports a seat and/or enables the seat to slide forward and backward). The connector, by coupling the vertical post to the horizontal post, provides additional support and structure to the seat post without requiring additional structural or bracing components, among other benefits.

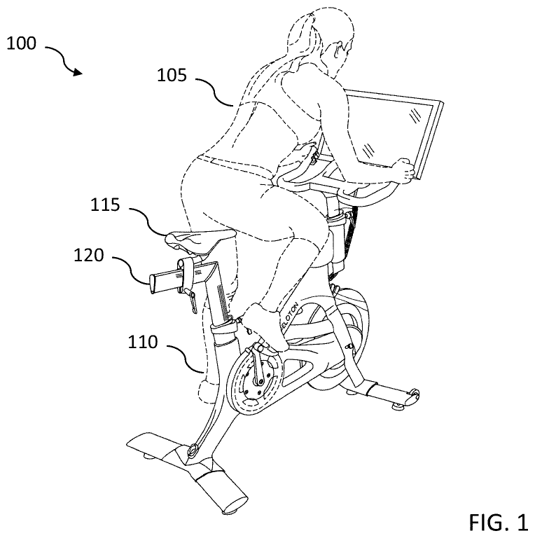

The seat post, as described herein, may be for use with an exercise bicycle. FIG. 1 is a diagram illustrating a suitable exercise bicycle 100. A rider 105 of the exercise bicycle 100 may be supported by a frame 110. The rider 105, during some or all of an exercise activity associated with the exercise bicycle 100, sits on a seat or saddle 115. The seat or saddle 115 is supported and/or positioned by a seat post 120, which is coupled to the frame 110 of the exercise bicycle 100.

For example, a lower post of the seat post 120 may be disposed into or otherwise coupled to a seat tube or other frame tube of the exercise bicycle 100. The exercise bicycle 100 may include various positioning or adjustment mechanisms, which enable a user (or a group of users) to position the seat 115 at different heights (e.g., up or down). An upper post of the seat post 120 may also facilitate certain adjustments, such as positioning the seat 115 at different horizontal positions (e.g., adjusted in a forward or backward direction) with respect to handlebars of the exercise bicycle 100).

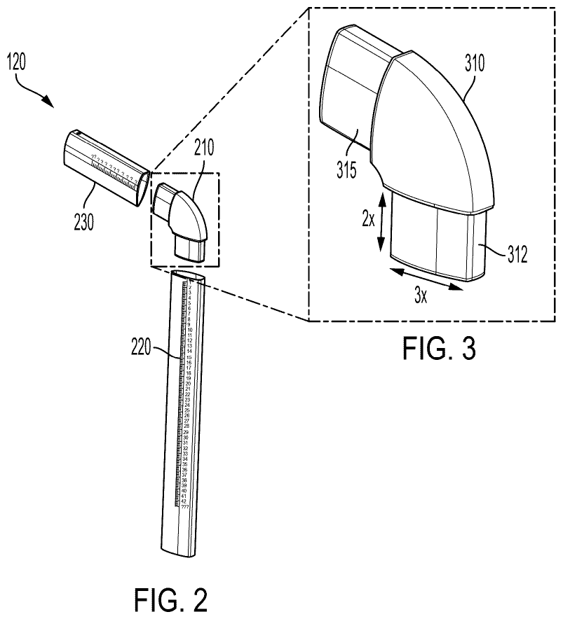

FIG. 2 is a diagram illustrating components of the seat post 120. The seat post 120 includes an elbow connector 210, a vertical post 220, and a horizontal post 230. The elbow connector 210, in some cases, includes extensions that are placed, positioned, and/or disposed within an internal cavity of the vertical post 220 and/or the horizontal post 230, in order to attach or fix the posts 220, 230 to the elbow connector 210 to form the seat post 120.

In some cases, the extensions have a geometry (e.g., a cross-sectional shape) that matches or mates with an internal shape of the posts. In some cases, once positioned or disposed, the elbow connector 210 may be welded to top rims or edges of the posts 220, 230, to secure the posts 220, 230 to the elbow connector 210.

FIG. 3 depicts the elbow connector 210. The elbow connector 210 include two extensions 312, 315 and a bend section 310 or coupling section. The extensions (e.g., a lower extension 312 and an upper extension 315) have a greater area, length, or surface area, such that they extend into the posts 220, 230 to secure the elbow connector 210 to the posts 220, 230. Thus, one or both extensions may have a length that is relative to a width of the post 120, where the width is measured by a width of the elbow connector 210, a width of the one of the posts 220, 230, or a width of the extension itself.

For example, each extension can have a length that is 40 millimeters (where the width, or length of a diameter of the post, is 60 millimeters). Thus, in various embodiments, the extension lengths can follow a ratio of 2×:3× with respect to the width of elbow connector 210, or higher (e.g., 3×:4×, 4×:4× (or 1×:1×), and so on), as depicted in FIG. 3.

In some embodiments, the extensions 312, 315, or shanks, can facilitate or provide a larger area for welding, as well as support other attachment mechanisms. Further, the extension can tightly fit into the openings of the posts 220, 230, and in some cases, provide additional support for securement for a seat when fixed or attached.

In some cases, one of the extensions may have a length that is longer than the other extension. For example, the upper extension 315, due to greater forces placed on the horizontal post 230, may have a greater length than the lower extension 312. As another example, the lower extension 312, for certain configurations that support a high seat height or positioning, may be longer than the upper extension 315.

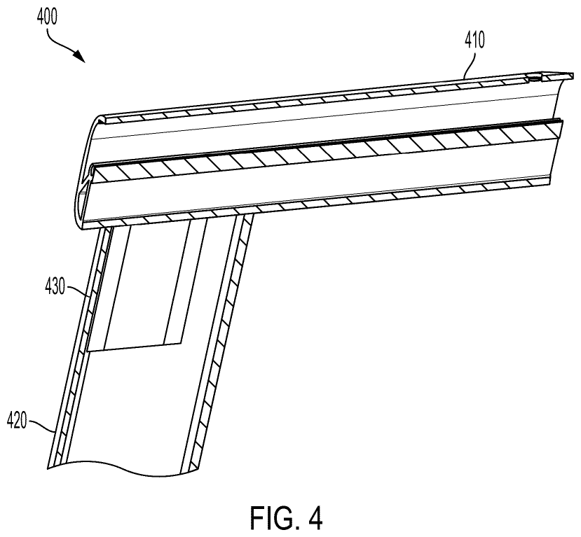

FIG. 4 depicts an example implementation of a seat post 400 for an exercise bicycle. The seat post 400 includes a horizontal post 410, which couples to and/or supports a seat or saddle, and a vertical post 420, which positions the seat or saddle and couples the sear post 400 to an exercise bicycle. The horizontal post 410 is coupled to the vertical post 420 via an internal extension 430, such as one or more of the extensions described herein.

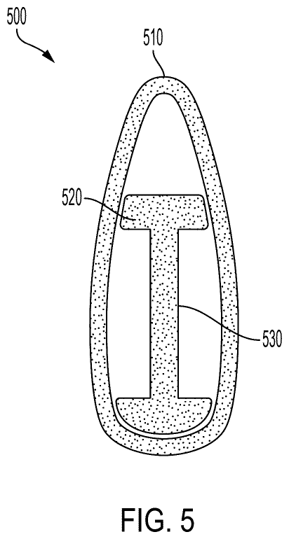

As described herein, the extensions may include a cross-sectional shape or geometry that facilitates fitting into an internal cavity of a post. FIG. 5 is a diagram illustrating a cross-sectional view 500 of a post 510 and an extension 520. The extension 520 may have an I-beam shape 530 or other similar shape that provides strength for the extension while also firmly or tightly fitting into the internal cavity of the post 510 (where the post 510 may be one or more of the posts described herein).

Thus, in various embodiments, a seat post for an exercise bicycle may include a multi-component structure where a coupling or connector component includes extensions that fit within support posts, such as vertical posts and/or horizontal posts. The extensions may have lengths that facilitate a balance of structural integrity and efficiency of costs and manufacturing processes, among other benefits.

### Example Embodiments of the Technology

The technology described herein may be implemented in various example embodiments, including the following.

In some embodiments, a seat post for an exercise bicycle includes a vertical support post, a horizontal support post, and an elbow connector. The elbow connector includes a lower extension, disposed within an opening of the vertical support post, having a length that is at least two thirds a width of the elbow connector and an upper extension, disposed within an opening of the horizontal support post, having a length that is at least two thirds the width of the elbow connector.

In some cases, the lower extension is disposed within an internal cavity of the vertical support post and the upper extension is disposed within an internal cavity of the horizontal support post.

In some cases, the length of the upper extension is greater than the length of the lower extension.

In some cases, the length of the lower extension is greater than the length of the upper extension.

In some cases, the length of the upper extension is equal to the length of the lower extension.

In some cases, the length of the lower extension or the length of the upper extension is equal to the width of the elbow connector.

In some cases, the length of the lower extension or the length of the upper extension is between two thirds of the width of the elbow connector and equal to the width of the elbow connector.

In some cases, the vertical seat post is welded to the lower extension of the elbow connector.

In some embodiments, an exercise bicycle includes a frame, a seat, and a seat post that supports the seat and is coupled to the frame. The seat post includes a vertical support post, a horizontal support post, and an elbow connector, where the elbow connector includes a lower extension, disposed within an opening of the vertical support post, having a length that is at least two thirds a width of the elbow connector, and an upper extension, disposed within an opening of the horizontal support post, having a length that is at least two thirds the width of the elbow connector.

In some embodiments, a seat post includes a first post configured to support a saddle, a second post configured to position the saddle above an exercise bicycle, and a connector that couples the first post to the second post, where the connector includes a first extension that is disposed within the first post and a second extension that is disposed within the second post and wherein the first extension and the second extension have a length to width ratio that is 2:3 or greater.

In some cases, the length to width ratio of the first extension is different than the length to width ratio of the second extension.

In some cases, a length of the first extension is greater than a length of the second extension.

In some cases, a length of the second extension is greater than a length of the first extension.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A seat post for an exercise bicycle, the seat post comprising:
a vertical support post;
a horizontal support post; and
an elbow connector,
wherein the elbow connector includes:
a lower extension, disposed within an opening of the vertical support post, having a length that is at least two thirds a width of the elbow connector; and
an upper extension, disposed within an opening of the horizontal support post, having a length that is at least two thirds the width of the elbow connector.

2. The seat post of claim 1, wherein the lower extension is disposed within an internal cavity of the vertical support post and the upper extension is disposed within an internal cavity of the horizontal support post.

3. The seat post of claim 1, wherein the length of the upper extension is greater than the length of the lower extension.

4. The seat post of claim 1, wherein the length of the lower extension is greater than the length of the upper extension.

5. The seat post of claim 1, wherein the length of the upper extension is equal to the length of the lower extension.

6. The seat post of claim 1, wherein the length of the lower extension or the length of the upper extension is equal to the width of the elbow connector.

7. The seat post of claim 1, wherein the length of the lower extension or the length of the upper extension is between two thirds of the width of the elbow connector and equal to the width of the elbow connector.

8. The seat post of claim 1, wherein the vertical seat post is welded to the lower extension of the elbow connector.

9. An exercise bicycle, comprising:
a frame;
a seat; and
a seat post that supports the seat and is coupled to the frame,
wherein the seat post includes:
a vertical support post;
a horizontal support post; and
an elbow connector,
wherein the elbow connector includes:
a lower extension, disposed within an opening of the vertical support post, having a length that is at least two thirds a width of the elbow connector; and
an upper extension, disposed within an opening of the horizontal support post, having a length that is at least two thirds the width of the elbow connector.

10. The exercise bicycle of claim 9, wherein the lower extension is disposed within an internal cavity of the vertical support post and the upper extension is disposed within an internal cavity of the horizontal support post.

11. The exercise bicycle of claim 9, wherein the length of the upper extension is greater than the length of the lower extension.

12. The exercise bicycle of claim 9, wherein the length of the lower extension is greater than the length of the upper extension.

13. The exercise bicycle of claim 9, wherein the length of the upper extension is equal to the length of the lower extension.

14. The exercise bicycle of claim 9, wherein the length of the lower extension or the length of the upper extension is equal to the width of the elbow connector.

15. The exercise bicycle of claim 9, wherein the length of the lower extension or the length of the upper extension is between two thirds of the width of the elbow connector and equal to the width of the elbow connector.

16. The exercise bicycle of claim 9, wherein the vertical seat post is welded to the lower extension of the elbow connector.

17. A seat post, comprising:
a first post configured to support a saddle;
a second post configured to position the saddle above an exercise bicycle; and
a connector that couples the first post to the second post,
wherein the connector includes a first extension that is disposed within the first post and a second extension that is disposed within the second post,
wherein the first extension and the second extension have a length to width ratio that is 2:3 or greater.

18. The seat post of claim 17, wherein the length to width ratio of the first extension is different than the length to width ratio of the second extension.

19. The seat post of claim 17, wherein a length of the first extension is greater than a length of the second extension.

20. The seat post of claim 17, wherein a length of the second extension is greater than a length of the first extension.
